(19) United States
(12) Patent Application Publication
(10) Pub. No.: US 2014/0198524 A1
(43) Pub. Date: Jul. 17, 2014

(54) LIGHT GUIDE PLATE WITH V-SHAPED MICRO-STRUCTURES ON LIGHT OUTPUT SURFACE

(71) Applicant: HON HAI PRECISION INDUSTRY CO., LTD., New Taipei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 13/777,068

(22) Filed: Feb. 26, 2013

(30) Foreign Application Priority Data
Jan. 17, 2013 (TW) 102101715

(51) Int. Cl. F21V 8/00

(52) U.S. Cl. CPC G02B 6/0036
USPC 362/607

(57) ABSTRACT

A light guide plate includes a bottom surface and a light output surface opposite to the bottom surface. A number of scattering domes are positioned on the bottom surface. A number of V-shaped micro-structures are positioned on the light output surface.

### BACKGROUND

1. Technical Field

The present disclosure relates to a light guide plate.

2. Description of Related Art

Many light guide plates include a bottom surface and a light output surface opposite to the bottom surface. Scattering points formed on the bottom surface are used for scattering light so that light can be evenly distributed in the light guide plate. Yet, because light is scattered to different directions by the scattering points, light output from the light output surface will be transmitted to different directions, which will reduce the on-axis luminance of the light guide plate.

Therefore, it is desired to provide a light guide plate which can overcome the above mentioned problems.

### BRIEF DESCRIPTION OF THE DRAWINGS

FIG. 1 is a schematic, isometric view of a light guide plate according to an exemplary embodiment.

FIG. 2 is similar to FIG. 1, but viewed from another angle.

FIG. 3 is a sectional view taken alone line of the light guide plate of FIG. 1.

### DETAILED DESCRIPTION

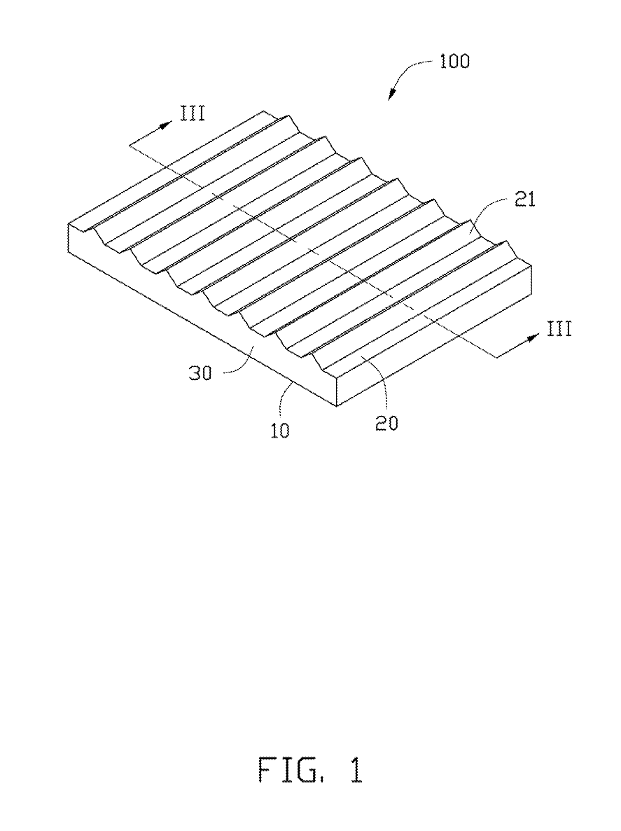

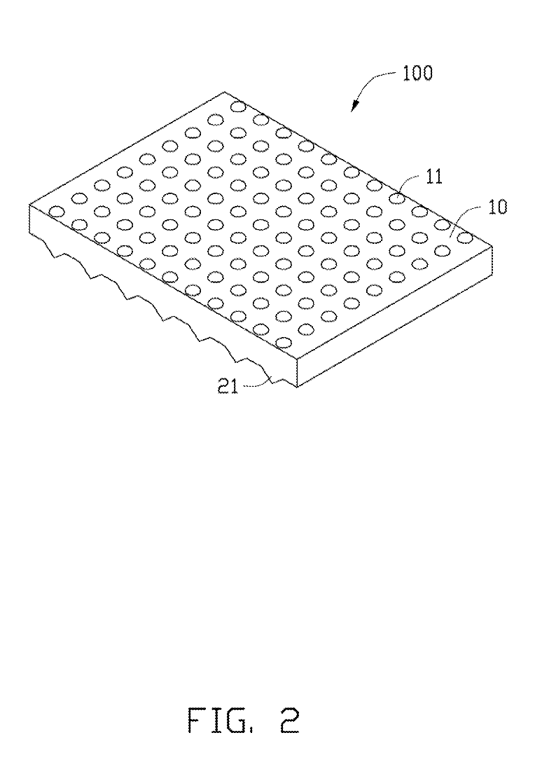

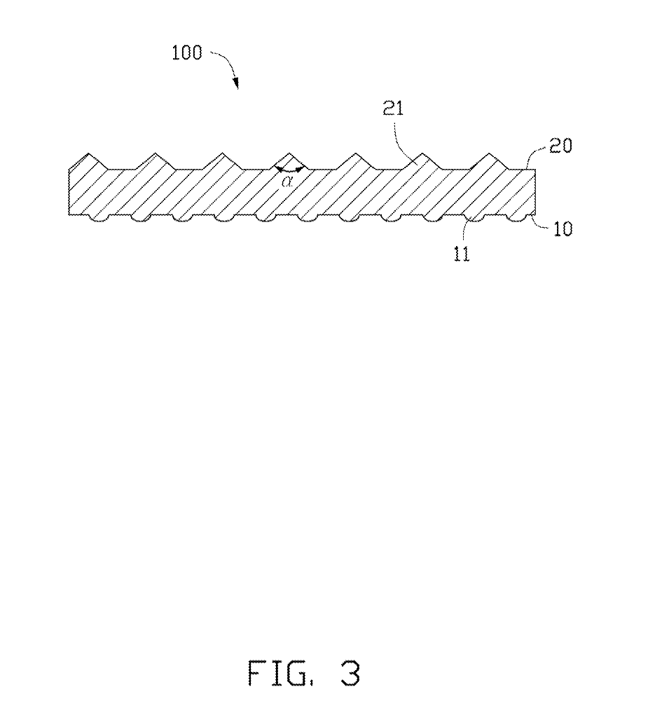

Referring to FIGS. 1-3, a light guide plate 100 according to an exemplary embodiment is shown. The light guide plate 100 is made of transparent material, such as transparent resin.

The light guide plate 100 includes a bottom surface 10, a light output surface 20 opposite to the bottom surface 10, and a side surface 30 connected to the bottom surface 10 and the light output surface 20. In this embodiment, the side surface 30 is a light incident surface of the light guide plate 100 and faces light sources (not shown).

Scattering domes 11 are formed on the bottom surface 10. The scattering domes 11 scatter light transmitted to the bottom surface 10 to evenly distribute in the light guide plate 100. In this embodiment, the scattering domes 11 are projections on the bottom surface 10.

V-shaped micro-structures 21 are formed on the light output surface 20. In this embodiment, the V-shaped micro-structures 21 are V-shaped strips parallel to each other. Each V-shaped micro-stricture 21 includes a top angle a away from the bottom surface 10.

The V-shaped micro-structures 21 are used to prevent total reflection of the light thus allowing more light to emit from the light output surface 20. Furthermore, the V-shaped micro-structures 21 can control an angle between the emitted light and the light output surface 20 to enhance an on-axis luminance of the light guide plate 100.

When the top angle a is between 80 degrees and 140 degrees, the on-axis luminance of the light guide plate 100 is maximized. Thus, the top angle a of the micro-structures 21 is optimally in the range from 80 degrees to 140 degrees.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A light guide plate comprising:
a bottom surface;
a plurality of scattering domes positioned on the bottom surface;
a light output surface opposite to the bottom surface, and
a plurality of V-shaped micro-structures positioned on the light output surface.

2. The light guide plate of claim 1, wherein each of the V-shaped micro-structures comprises a top angle away from the bottom surface.

3. The light guide plate of claim 2, wherein the top angle is in a range from 80 degrees to 140 degrees.

4. The light guide plate of claim 1, wherein the scattering domes are projections on the bottom surface.

5. The light guide plate of claim 1, wherein the V-shaped micro-structures are V-shaped strips.

6. The light guide plate of claim 5, wherein the V-shaped strips are parallel to and separate from each other.

7. The light guide plate of claim 1, further comprising a side surface connected to the bottom surface and the light output surface.
